(19) United States
(12) Patent Application Publication
(10) Pub. No.: US 2018/0285911 A1
(43) Pub. Date: Oct. 4, 2018

(54) OPTIMIZING PROFITABILITY IN FULFILLING WEBSITE-BASED ORDER

(71) Applicant: INTERNATIONAL BUSINESS MACHINES CORPORATION, Armonk, NY (US)

(72) Inventors: Jialin LI, Westford, MA (US); Pradeep K. NANJUNDASWAMY, Bangalore (IN); Srikanth SUNDARARAJAN, Cambridge, MA (US); Danai TENGTRAKOOL, Burlington, MA (US)

(21) Appl. No.: 15/471,586

(22) Filed: Mar. 28, 2017

(51) Int. Cl. G06Q 30/02; G06Q 30/06

(52) U.S. Cl. CPC G06Q 30/0223; G06Q 30/0639; G06Q 30/0635

(57) ABSTRACT

Methods, computer program products, and systems are presented. The methods include, for instance: obtaining content of the website-based order from a user, selecting a physical location from a plurality of locations for a venue that are available for a retrieval of the website-based order and predicted as being most profitable for the venue, generating a notification that includes the physical location and an award available to the user upon the website-based order being fulfilled from the physical location. Upon ascertaining that the order has been placed with the physical location for fulfilling the website-based order, the system verifies if the user picked up the order at the physical location and provides the award.

### TECHNICAL FIELD

The present disclosure relates to e-commerce and marketing technology, and more particularly to methods, computer program products, and systems for calculating cost/benefit with fulfilment of a website-based order, and optimizing profitability thereof.

### BACKGROUND

Conventionally, in fulfilling website-based orders by in-store pickups, location choices are offered based on distance between geographic locations of the users who place the orders and any available store location.

### SUMMARY

The shortcomings of the prior art are overcome, and additional advantages are provided, through the provision, in one aspect, of a method. The method for fulfilling a website-based order by a venue includes, for example: obtaining, by at least one processor, content of the website-based order from a user by use of a website, wherein the content includes at least one item; selecting, by the at least one processor, a physical location from a plurality of locations for a venue, wherein a retrieval of the website-based order from the physical location by the user is predicted as being most profitable for the venue, amongst respective retrievals of the website-based order from the respective locations; generating, by the at least one processor, a notification that includes the physical location, wherein the notification specifies an award that is available to the user upon the website-based order being fulfilled from the physical location according to at least one condition; sending, by the at least one processor, the notification to the user; determining, by the at least one processor, that the user has placed the website-based order and has selected the physical location for fulfilling the website-based order; and responsive to verifying that the user has picked up the website-based order from the physical location according to the at least one condition, providing, by the at least one processor, the award to the user.

Additional features are realized through the techniques set forth herein. Other embodiments and aspects, including but not limited to computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system for optimizing pickup location in fulfilling an website-based order by a venue, in accordance with one or more embodiments set forth herein;

FIG. 2 depicts a flowchart performed by the pickup location optimizer of the system, in accordance with one or more embodiments set forth herein;

FIG. 3 depicts a cloud computing node according to an embodiment of the present invention;

FIG. 4 depicts a cloud computing environment according to an embodiment of the present invention; and

FIG. 5 depicts abstraction model layers according to an embodiment of the present invention.

### DETAILED DESCRIPTION

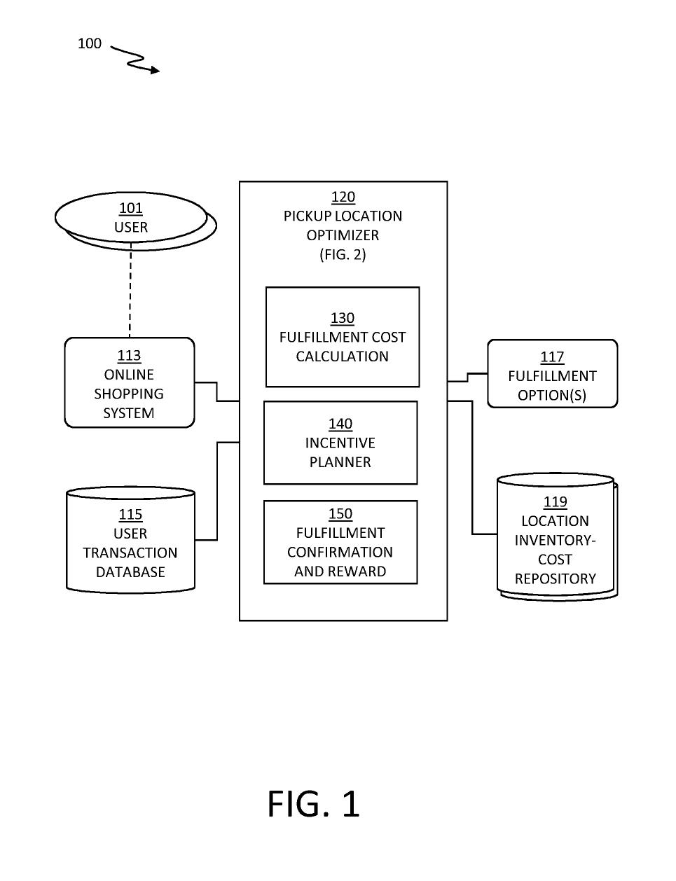

FIG. 1 depicts a system 100 for optimizing pickup location in fulfilling a website-based order by a venue, in accordance with one or more embodiments set forth herein.

The system 100 providing services for optimizing pickup location of the website-based order for the venue includes a user 101 amongst one or more user who is shopping online by use of a website implementing an online shopping system 113 and will travel to a physical location for a pickup. The online shopping system 113 may be any e-commerce site providing online shopping services for the venue that has multiple locations for the user 101 to pick up a website-based order, and a store pickup option in fulfilling the website-based order may be selected by the user 101 with the online shopping system 113. The online shopping system 113 is coupled to a pickup location optimizer 120. The pickup location optimizer 120 is coupled to a user transaction database 115, one or more fulfillment options 117, and a location inventory-cost repository 119. The user transaction database 115 includes all transaction record of the user 101 including the order history and a wish list. The order history may include one or more order with items ordered and corresponding fulfillment status, for past orders and/or an order that is presently being processed. Respective fulfillment status of the orders may include status indicating whether or not the user 101 receives the items in an order, as well as other details of the fulfillment including time, location, and whether or not the ordered items had been shipped or picked up. The one or more fulfillment options 117 include all fulfillment options available in order to fulfill an order placed by the user 101 such as a free in-store pickup at a specific location and delivery options such as free 10-day shipping, express shipping at user's expense, etc. The location inventory-cost repository 119 includes inventories and associated cost of the inventories for each location of the venue that may fulfill the order placed by the user 101.

The pickup location optimizer 120 includes a fulfillment cost calculation process 130, an incentive planner 140, and a fulfillment confirmation and reward process 150. The pickup location optimizer 120 calculates costs corresponding to respective fulfillment options available from the fulfillment options 117 during a checkout of the items in a shopping cart as placed by the user 101. The pickup location optimizer 120 utilizes cost information stored in all location inventory-cost repositories of the venue, prospective sales, etc. The location inventory-cost repository 119 may correspond to a preferred location amongst all locations of the venue, as selected by the pickup location optimizer 120.

In this specification, a preferred location indicates a physical location of the venue that may benefit the venue the most by having the user 101 visit the preferred location and pick up the item according to various scenarios, by additional sales, minimized cost, etc. Also in this specification, a benefit indicates any gain by the venue either from reduced cost, saved labor, or from increased sales, etc. In cases where the venue may expect that the user 101 may purchase a second item upon vising a pickup location for a first item, then the pickup location optimizer 120 selects the preferred location from the locations that have the second item in stock such that a likely sales of the second item by the user 101 would not be lost due to unavailability. The pickup location optimizer 120 determines a likelihood of additional sales based on various factors such as whether or not the second item is in a wish list of the user 101, a shopping trend of buyers of the first item that also buys the second item, and/or the user 101 had purchased the second item often in the past, etc. In cases where the venue may reduce the most overall cost including inventory cost, labor cost, and/or transportation cost, etc., by offering an item for pickup at a certain location, then the pickup location optimizer 120 determines the certain location as the preferred location. In this specification, the inventory cost of an item indicates the cost of obtaining and carrying the item; the labor cost indicates the cost of processing a pickup order for the item; and the transportation cost indicates the cost of moving the item to another location desired by the user 101 for pickup.

The pickup location optimizer 120 also generates a notification to encourage the user 101 to pick up the item at the preferred location determined according to the fulfillment cost calculation. In cases where the user 101 placed an order designating the preferred location as a pick up location, the pickup location optimizer 120 verifies if the order had been picked up according to conditions specified with the awards and rewards the user 101 with the awards as offered accordingly. The fulfillment cost calculation process 130, the incentive planner 140, and the fulfillment confirmation and reward process 150 of the pickup location optimizer 120 represent respective functional elements of the pickup location optimizer 120, and may or may not be implemented as a corresponding physical process.

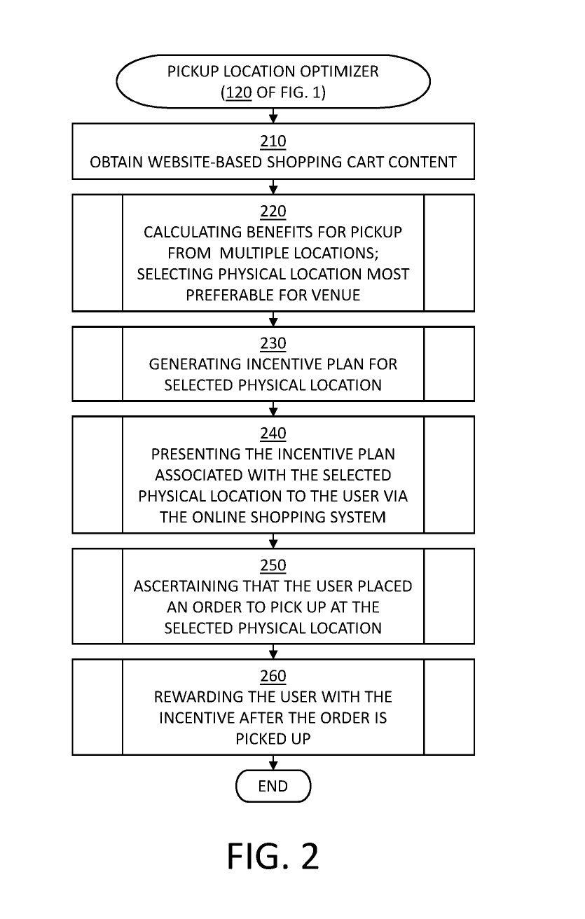

FIG. 2 depicts a flowchart performed by the pickup location optimizer 120 of FIG. 1, in accordance with one or more embodiments set forth herein.

In block 210, the pickup location optimizer 120 obtains content of a website-based shopping cart as the user puts an item in the shopping cart. Then the pickup location optimizer 120 proceeds with block 220.

In certain embodiments, the pickup location optimizer 120 may have a plurality of candidate items such that the pickup location optimizer 120 would be activated upon having the candidate items in the shopping cart.

In block 220, the pickup location optimizer 120 calculates one or more fulfillment options to check out the content of the shopping cart and respective costs corresponding to each fulfillment options involving multiple store locations. Consequently the pickup location optimizer 120 selects one or more physical location that may be preferred by the venue according to a preferred location configuration. Then the pickup location optimizer 120 proceeds with block 230.

In certain embodiments of the present invention, in order to select the physical location, the pickup location optimizer 120 may be configured to minimize cumulative costs involved in fulfilling the order for all items in the shopping cart from plurality of locations. The pickup location optimizer 120 calculates respective benefits that result from a certain item being picked up from the plurality of locations, and selects a location with the most benefit for the venue as a preferred location. The pickup location optimizer 120 may calculate the respective benefits per location based on inventory cost, labor cost, procurement/transfer cost, etc., of selling the certain item in the present volume in comparison to reducing the number of items from the stock by the number of items in the shopping cart. For example, where the user 101 is ordering one unit of the item, a first location has eleven (11) units of the item, and a second location has only one unit of the item, the pickup location optimizer 120 determines that the venue may minimize the overall cost by clearing the stock from the second location which flagged the item for markdown in two weeks at a reduced price, and determines the second location as an preferred location to present to the user 101 for picking the item up.

In certain embodiments of the present invention, the pickup location optimizer 120 may be configured to maximize additional sales that may be generated in one location but not in other locations, in order to select the physical location. In certain embodiments of the present invention, the pickup location optimizer 120 may be configured to maximize overall benefit, taking all factors such as the costs and profits from all locations, likely additional sales from locations wherein the additional sales item is available, likelihood of the additional sales, and combinations thereof, into account. For example, the first location and the second location both have the item being ordered by the user 101, and the pickup location optimizer 120 checks browsing history, searched items, and previous purchases and determines that the user 101 is likely to purchase another item very soon, possible on a next visit to one of the venue locations. Accordingly, the pickup location optimizer 120 selects the first location which carries another item as the preferred physical location over the second location which is out of stock with another item.

In block 230, the pickup location optimizer 120 generates one or more incentive plan to create a notification for the preferred physical location as selected from block 220, which specifies content of award that is offered to the user 101 on the condition that the user 101 picks up the order, placed for the content of the shopping cart, at the preferred physical location within a certain timeframe. For example, notifications from the same examples as block 220 may be “5% discount on one item; the second location; within 5 business days”, “10% of another item purchase; the first location; this weekend only”, etc. Then the pickup location optimizer 120 proceeds with block 240.

In block 240, the pickup location optimizer 120 presents the notification as generated in association with the preferred physical location from block 230 to the user 101 via a checkout screen, etc., of the online shopping system 113. The pickup location optimizer 120 receives input from the user 101 as selecting the preferred physical location and the associated notification in submitting the website-based order. In cases where the user 101 selects other location than the preferred physical location, and/or shipping to one or more address, the pickup location optimizer 120 terminates processing for the order, and may loop back to block 210 for processing another order for pickup location optimization. Then the pickup location optimizer 120 proceeds with block 250.

In block 250, the pickup location optimizer 120 ascertains that the user 101 placed the website-based order with a fulfillment option specifying in-store pickup from the preferred physical location, in response to the notification presentation in block 240. Then the pickup location optimizer 120 proceeds with block 260.

In block 260, the pickup location optimizer 120 rewards the user 101 with award offered in the notification responsive to verifying that the website-based order is picked up at the preferred physical location within a timeframe associated with the order/the notification, as selected by the user 101. In certain embodiments of the present invention, the pickup location optimizer 120 may send the award offered in the notification via email, text message, etc. Then the pickup location optimizer 120 terminates processing for the order, and may loop back to block 210 for processing another order for pickup location optimization.

Certain embodiments of the present invention may offer various technical computing advantages, including automated benefit optimization in managing a fulfillment option for a website-based order to a venue. Certain embodiments of the present invention calculate respective benefit corresponding to the pickups at plurality of locations and select a physical location which renders the most benefit and/or the least cost for the venue. Cost/profit calculation may include inventory availability, inventory cost, labor cost, inventory markdown strategy/schedule and corresponding profitability, determination of items having high probability of additional purchase upon a store visit for a pickup and availability of inventory on such items, based on purchase history/wish list of the user, overall fulfillment profitability in the context of ordered quantity and available inventory at individual location. By use of multithreading and/or multiprocessing, any number of orders may be simultaneously processed for pickup location optimization. Certain embodiments of the present invention may be implemented by use of a cloud platform/data center, and the pickup location optimization service may be provided as a subscribed service for online venues with plurality of locations. Certain embodiments of the present invention improves the profitability of the online venues and/or of respective locations, by providing opportunities to optimize pickup locations of website-based orders, by incentivizing the users to select respective physical locations for pickup of the orders.

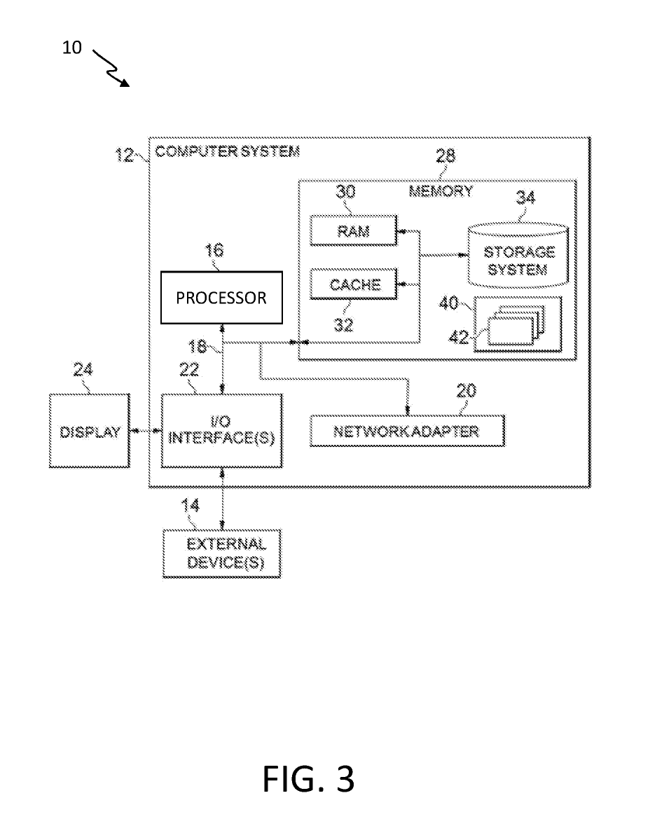

FIGS. 3-5 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a computer system/cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

As shown in FIG. 3, computer system 12 in cloud computing node 10 is shown in the form of a general-purpose computing device. The components of computer system 12 may include, but are not limited to, one or more processors 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. Each of the operating system, one or more application programs, other program processes, and program data or some combination thereof, may include an implementation of the pickup location optimizer 120 of FIG. 1. Program processes 42, as in the pickup location optimizer 120 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processors, external disk drive arrays, RAID systems, tape drives, and data archival storage systems, etc.

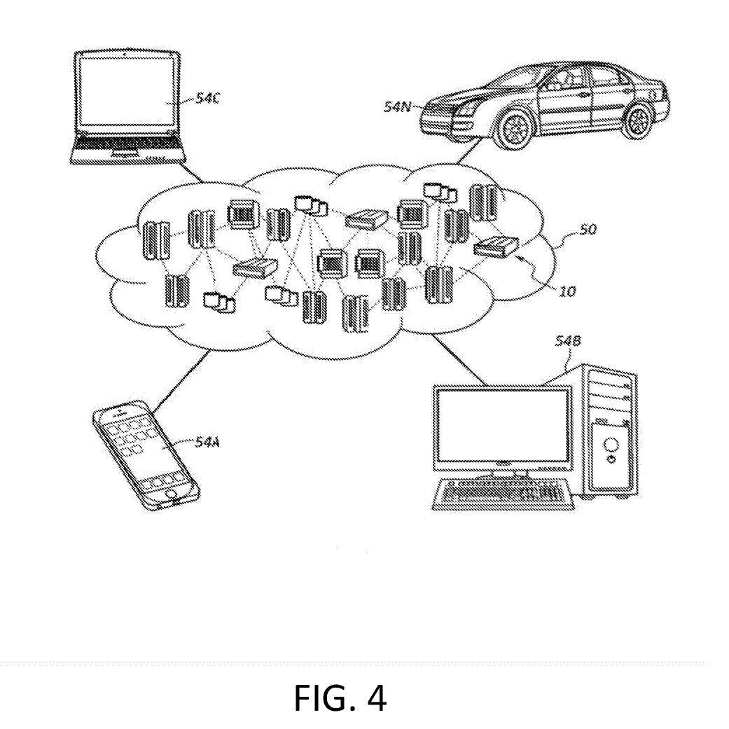

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

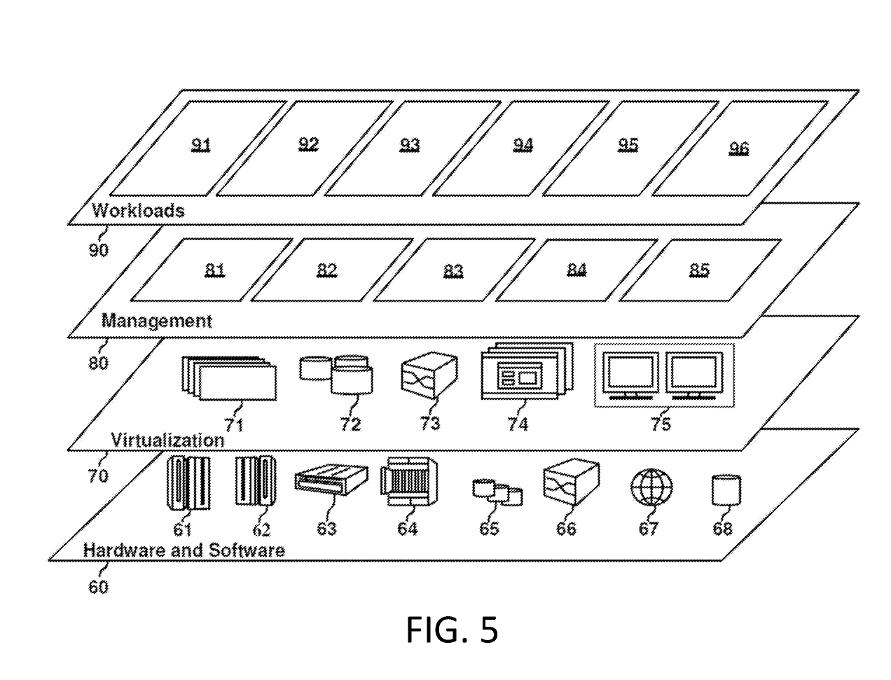

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components for the pickup location optimizer 96, as described herein. The processing components 96 can be understood as one or more program 40 described in FIG. 3.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method for fulfilling a website-based order by a venue, comprising:
obtaining, by at least one processor, content of the website-based order from a user by use of a website, wherein the content includes at least one item;
selecting, by the at least one processor, a physical location from a plurality of locations for a venue, wherein a retrieval of the website-based order from the physical location by the user is predicted as being most profitable for the venue, amongst respective retrievals of the website-based order from the respective locations;
generating, by the at least one processor, a notification that includes the physical location, wherein the notification specifies an award that is available to the user upon the website-based order being fulfilled from the physical location according to at least one condition;
sending, by the at least one processor, the notification to the user;
determining, by the at least one processor, that the user has placed the website-based order and has selected the physical location for fulfilling the website-based order; and
responsive to verifying that the user has picked up the website-based order from the physical location according to the at least one condition, providing, by the at least one processor, the award to the user.

2. The computer implemented method of claim 1, the selecting comprising:
calculating respective fulfilment costs associated with fulfilling the website-based order at each location of the plurality of locations of the venue wherein the user may pick up the website-based order; and
identifying a location that is associated with the least fulfilment cost as the physical location.

3. The computer implemented method of claim 1, the selecting comprising:
discovering that an item present in the website-based order is scheduled for markdown in near future at a location but not in other locations; and
identifying the location having the item scheduled for markdown as the physical location.

4. The computer implemented method of claim 1, the selecting comprising:
calculating respective profits that may be added by fulfilling the website-based order at each location of the plurality of locations of the venue wherein the user may pick up the website-based order; and
identifying a location that may generate the most profit as the physical location.

5. The computer implemented method of claim 1, the selecting comprising:
determining another item, not present in the website-based order, that the user is likely to purchase when the user picks up the website-based order at the physical location, by use of a purchase history of the user, a wish list of the user, a shopping trend of all users, and combinations thereof; and
identifying a location that has another item in stock as the physical location.

6. The computer implemented method of claim 1, wherein the benefit on the venue corresponds to, for each location, inventory availabilities, inventory costs, labor costs, an inventory markdown schedule, profit changes corresponding to the inventory markdown schedule, a list of items that the user is likely to purchase upon a visit for a pickup, and combinations thereof.

7. The computer implemented method of claim 1, wherein the award of the notification may include a coupon or other promotions, and wherein the one or more condition may include a pickup timeframe, such that only the user who picks up the website-based order within the pickup timeframe may be rewarded with the award.

8. A computer program product comprising:
a computer readable storage medium readable by one or more processor and storing instructions for execution by the one or more processor for performing a method for fulfilling a website-based order by a venue, comprising:
obtaining content of the website-based order from a user by use of a website, wherein the content includes at least one item;
selecting a physical location from a plurality of locations for a venue, wherein a retrieval of the website-based order from the physical location by the user is predicted as being most profitable for the venue, amongst respective retrievals of the website-based order from the respective locations;
generating a notification that includes the physical location, wherein the notification specifies an award that is available to the user upon the website-based order being fulfilled from the physical location according to at least one condition;
sending the notification to the user;
determining that the user has placed the website-based order and has selected the physical location for fulfilling the website-based order; and
responsive to verifying that the user has picked up the website-based order from the physical location according to the at least one condition, providing the award to the user.

9. The computer program product of claim 8, the selecting comprising:
calculating respective fulfilment costs associated with fulfilling the website-based order at each location of the plurality of locations of the venue wherein the user may pick up the website-based order; and
identifying a location that is associated with the least fulfilment cost as the physical location.

10. The computer program product of claim 8, the selecting comprising:
discovering that an item present in the website-based order is scheduled for markdown in near future at a location but not in other locations; and
identifying the location having the item scheduled for markdown as the physical location.

11. The computer program product of claim 8, the selecting comprising:
calculating respective profits that may be added by fulfilling the website-based order at each location of the plurality of locations of the venue wherein the user may pick up the website-based order; and
identifying a location that may generate the most profit as the physical location.

12. The computer program product of claim 8, the selecting comprising:
determining another item, not present in the website-based order, that the user is likely to purchase when the user picks up the website-based order at the physical location, by use of a purchase history of the user, a wish list of the user, a shopping trend of all users, and combinations thereof; and
identifying a location that has another item in stock as the physical location.

13. The computer program product of claim 8, wherein the benefit on the venue corresponds to, for each location, inventory availabilities, inventory costs, labor costs, an inventory markdown schedule, profit changes corresponding to the inventory markdown schedule, a list of items that the user is likely to purchase upon a visit for a pickup, and combinations thereof.

14. The computer program product of claim 8, wherein the award of the notification may include a coupon or other promotions, and wherein the one or more condition may include a pickup timeframe, such that only the user who picks up the web site-based order within the pickup timeframe may be rewarded with the award.

15. A system comprising:
a memory;
one or more processor in communication with memory; and
program instructions executable by the one or more processor via the memory to perform a method for fulfilling a website-based order by a venue, comprising:
obtaining content of the website-based order from a user by use of a website, wherein the content includes at least one item;
selecting a physical location from a plurality of locations for a venue, wherein a retrieval of the website-based order from the physical location by the user is predicted as being most profitable for the venue, amongst respective retrievals of the website-based order from the respective locations;
generating a notification that includes the physical location, wherein the notification specifies an award that is available to the user upon the website-based order being fulfilled from the physical location according to at least one condition;
sending the notification to the user;
determining that the user has placed the website-based order and has selected the physical location for fulfilling the website-based order; and
responsive to verifying that the user has picked up the website-based order from the physical location according to the at least one condition, providing the award to the user.

16. The system of claim 15, the selecting comprising:
calculating respective fulfilment costs associated with fulfilling the website-based order at each location of the plurality of locations of the venue wherein the user may pick up the website-based order; and
identifying a location that is associated with the least fulfilment cost as the physical location.

17. The system of claim 15, the selecting comprising:
discovering that an item present in the website-based order is scheduled for markdown in near future at a location but not in other locations; and
identifying the location having the item scheduled for markdown as the physical location.

18. The system of claim 15, the selecting comprising:
calculating respective profits that may be added by fulfilling the website-based order at each location of the plurality of locations of the venue wherein the user may pick up the website-based order; and
identifying a location that may generate the most profit as the physical location.

19. The system of claim 15, the selecting comprising:
determining another item, not present in the website-based order, that the user is likely to purchase when the user picks up the website-based order at the physical location, by use of a purchase history of the user, a wish list of the user, a shopping trend of all users, and combinations thereof; and
identifying a location that has another item in stock as the physical location.

20. The system of claim 15, wherein the benefit on the venue corresponds to, for each location, inventory availabilities, inventory costs, labor costs, an inventory markdown schedule, profit changes corresponding to the inventory markdown schedule, a list of items that the user is likely to purchase upon a visit for a pickup, and combinations thereof, wherein the award of the notification may include a coupon or other promotions, and wherein the one or more condition may include a pickup timeframe, such that only the user who picks up the website-based order within the pickup timeframe may be rewarded with the award.
